(19) United States
(12) Patent Application Publication
(10) Pub. No.: US 2019/0152008 A1
(43) Pub. Date: May 23, 2019

(54) CONTROL SYSTEM AND CONTROL METHOD

(71) Applicant: INSTITUTE FOR INFORMATION INDUSTRY, Taipei (TW)

(72) Inventors: Chow-Shih Wang, Changhua County (TW); Yu-Chi Liu, Taichung City (TW); Yao-Cheng Tsai, Changhua County (TW); Bo-Jyun Jhang, Taichung City (TW); Hung-Sheng Chiu, Taichung City (TW)

(21) Appl. No.: 15/830,005

(22) Filed: Dec. 4, 2017

(30) Foreign Application Priority Data
Nov. 17, 2017 (TW) 106139979

(51) Int. Cl. B23Q 11/12; B23C 1/06

(52) U.S. Cl. CPC B23Q 11/126; B23C 2260/76; B23C 2250/12; B23C 1/06

(57) ABSTRACT

The present invention relates to a control system and control method. The control system is applied to a machine tool and includes a horizontal monitor unit, a temperature monitor unit, a temperature adjustment device and a controller. The horizontal monitor unit is configured to measure a horizontal angle of a table and the temperature monitor unit is configured to measure a temperature information of a sensing area in a machining device. The controller receives the horizontal angle and the temperature information, then generates a compensation signal to the temperature adjustment device to change the temperature of an adjusting area in the machining device so that the horizontal angle of the table and the vertical inclination of the machining device are orthogonal to each other.

### RELATED APPLICATIONS

This application claims priority to Taiwan Application Serial Number 106139979, filed Nov. 17, 2017, which is herein incorporated by reference.

### BACKGROUND

### Field of Invention

The present invention relates to a control system and a method. More particularly, the present invention for correcting the error angle between the table and the machining device of a machine tool when it is in operation.

### Description of Related Art

For example, when the milling cutter of the milling machine processes the workpiece on the table, both the milling cutter and the working table may produce deformation due to long time force, vibration or high temperature, and then produce some slight skew. This slight deflection is likely to seriously affect the accuracy of the finished product. Similarly, the lathe has the same problem.

At present, there is no effective method to solve the problem of skew mentioned above. The manufacturers can only maintain the milling machine regularly in the downtime state to ensure that the milling cutter can process the workpiece on the table at orthogonal angles.

This means that in processing operations, it is completely impossible for the manufacturer to confirm whether the milling machine has been skewed or not. Nor can the manufacturer determine exactly how the skew of the milling cutter will affect the machining accuracy. Therefore, there is an urgent need for a control system that can correct errors to solve the above problems.

### SUMMARY

The invention provides a control system applied to a machine tool, the machine tool includes a table and a machining device, the control system comprising at least one horizontal monitoring unit, at least one temperature measuring component, at least one temperature control device and a processing unit. The horizontal monitoring unit is arranged on the table and configured to measure a horizontal angle of the table. The temperature measuring component is arranged on a sensing area of the machining device and configured to detect a temperature information of the sensing area. The temperature control device is arranged on a control area of the machining device and configured to adjust the temperature of the control area. The processing unit is electrically coupled to the horizontal monitoring unit, the temperature measuring component and the temperature control device; the processing unit is configured to receive the horizontal angle from the horizontal monitoring unit and the temperature information from the temperature measuring component, and according to the horizontal angle and the temperature information, outputs a compensation signal to the temperature control device according to the horizontal angle and the temperature information, so that the temperature control device changes the temperature of the control area on the machining device.

The invention provides a control method applied to a machine tool and a control system; the machine tool includes a table and a machining device and the control method makes the control system establish a compensation data in the control system, then obtain a horizontal angle of the table and a temperature information of a sensing area on the machining device respectively through a horizontal monitoring unit and a temperature measuring component of the control system. The control system outputs a compensation signal according to the compensation data. Finally, according to the compensation signal, driving a temperature control device in the control system to change the temperature of a control area on the machining device.

Through the technical characteristics, the control system can monitor horizontal angle of the table and the temperature of the machining device, and real-time judge whether there is an error angle between the machining device and the table. At the same time, the control system can adjust the temperature of the machining device through the compensation signal to correct the error angle, so that the manufacturer does not have to put the machine tool into a state of downtime and carry out comprehensive maintenance at great cost. The machine tool has lower cost, higher precision and easier management and monitoring.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 shows a schematic diagram of a control system for one of the embodiments of the present invention; and

FIG. 2 shows a flow chart of the steps of one of the embodiments of the present invention.

### DETAILED DESCRIPTION

For the embodiment below is described in detail with the accompanying drawings, embodiments are not provided to limit the scope of the present invention. Moreover, the operation of the described structure is not for limiting the order of implementation. Any device with equivalent functions that is produced from a structure formed by a recombination of elements is all covered by the scope of the invention. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

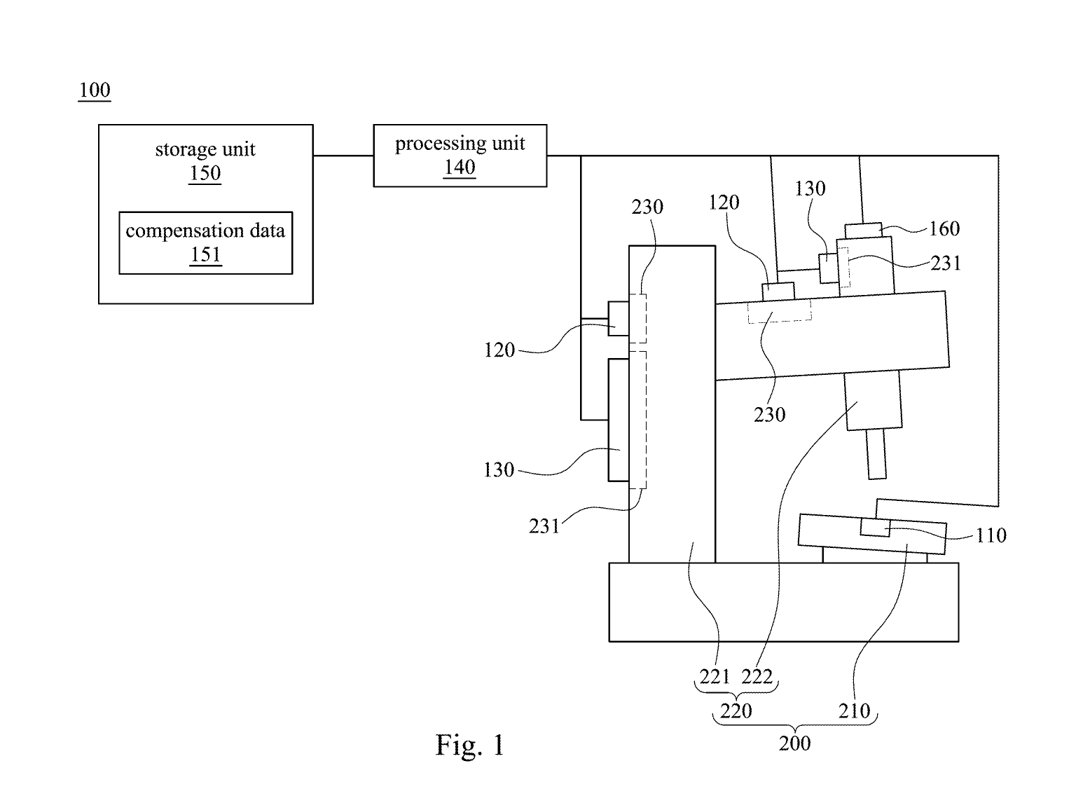

FIG. 1 shows a schematic diagram of a control system for one of the embodiments of the present invention. The control system 100 is applied to a machine tool 200. In order to facilitate understanding of the techniques of the invention the configuration of the machine tool 200 is described as follows: the machine tool 200 (e.g. milling machine) includes at least a table 210 and a machining device 220. The table 210 is used to place a workpiece to be processed, and the machining device 220 (e.g. milling cutter) corresponds to the table 210 for cutting.

The control system 100 includes a horizontal monitoring unit 110, a plurality of temperature measuring components 120, a plurality of temperature control devices 130 and a processing unit 140. The horizontal monitoring unit 110 (e.g. spirit level or bubble level, or Level instrument) is arranged on the table 210 and configured to measure a horizontal angle of the table 210. Each temperature measuring component 120 (for example, a thermometer) is arranged on one of sensing areas 230 of the machining device 220 and configured to detect a temperature information corresponding to the sensing area 230.

Each of the temperature control devices 130 is arranged on a control area 231 of the machining device 220 and configured to adjust the temperature of the control area 231. In one embodiment the control area 231 is adjacent to the sensing area 230. For example, the sensing area 230 is adjacent to or close to the control area 231. In another embodiment, the sensing area 230 is located on the surface of the machining device 220 and the control area 231 is an internal area corresponding to the sensing area 230 on the machining device 220.

However, in other embodiments, the sensing area 230 and the control area 231 do not need to be adjacent and paired. The manufacturer may first detect the characteristics such as temperature variations and thermal deformation of each part on the machining device 220. The sensing area 230 and the control area 231 are also planned. Details will be discussed later.

The processing unit 140 may be a central processing unit (CPU) or an application-specific integrated circuit(ASIC). The processing unit 140 is electrically coupled to the horizontal monitoring unit 110, the temperature measuring component 120 and the temperature control device 130. The processing unit 140 is configured to receive the horizontal angle from the horizontal monitoring unit 110 and the temperature information from the temperature measuring component 120, and according to the horizontal angle and the temperature information, outputs a compensation signal to the temperature control device 130 so that the temperature control device 130 adjusts the temperature of the control area 231 on the machining device 220.

The inventor found that when the machine tool 200 was in operation, the machining device 220 would heat up due to the heat of the surrounding environment or internal parts, and the change of temperature would also affect the verticality of the machining device 220. Therefore, the inventor came up with an idea. If the current temperature of the machining device 220 can be monitored, an error angle required when the verticality of the machining device and the horizontal angle of the table maintain orthogonal can be calculated.

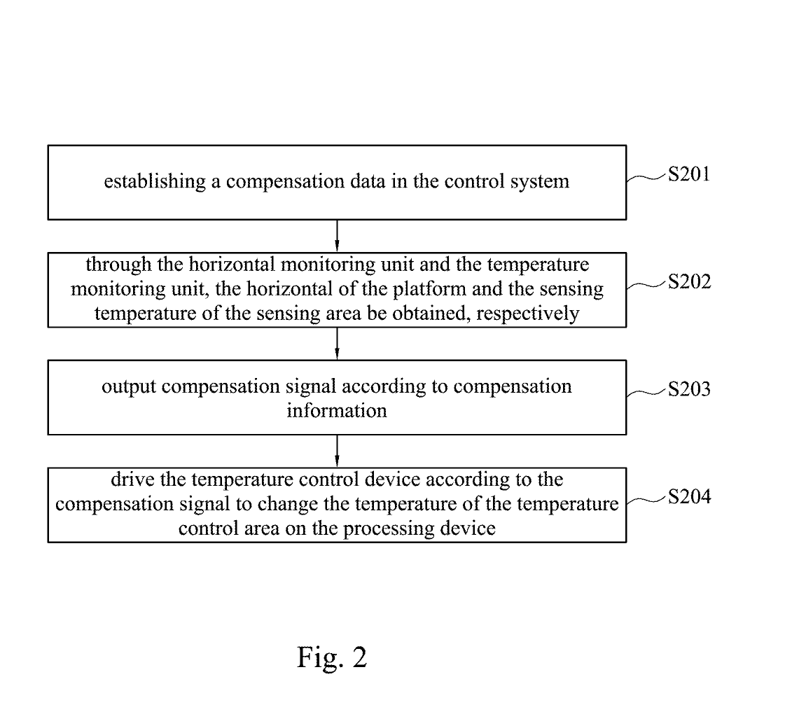

In order to enable persons in the art to understand more specifically the purpose of the present invention, a control method in one of the embodiments of the invention is described herein. FIG. 2 shows a flow chart of the steps of one of the embodiments of the present invention. In step S201, establishing a compensation data 151 in the control system 100. The compensation data 151 recording the change of the verticality of the machining device 220 when the control area 231 is at different temperatures, the content and establishment of which will be described in detail later.

In step S202, through a horizontal monitoring unit 110 and a temperature measuring component 120 of the control system 100, a horizontal angle of the table 210 and a temperature information of a sensing area 230 on the machining device 220 are obtained respectively.

In step S203, outputting a compensation signal according to the compensation data 151. The compensation signal is an electrical signal and used to adjust the temperature of the control area 231. For example, the compensation signal can be a voltage signal, a current signal or one of the instruction signal that the temperature control device 130 can recognize (in one embodiment is controlled by a voltage signal). In step S204, according to the compensation signal, driving a temperature control device 130 in the control system 100 to adjust the temperature of a control area 231 on the machining device 220.

In general, the control area 231 may be adjacent to the sensing area 230, overlapped with the sensing area 230 or not overlapping with the sensing area 230. When the control area 231 has a temperature change, it will cause the machining device 220 to change the verticality due to the heat rise and cold contraction, so that the machining device 220 can adjust its verticality with the change of temperature.

In other embodiments, the compensation signal changes the temperature of the control area 231 and the verticality of the machining device 220 (e.g. spindle 222) and the horizontal angle of the table 210 maintain orthogonal. The control system 100 still includes a vertical monitoring unit 160. The vertical monitoring unit 160 is arranged on the machining device 220 and is electrically coupled to the processing unit 140. The vertical monitoring unit 160 configured to measure a verticality of the machining device 220 so that the processing unit 140 accurately calculates an error angle required when the verticality of the machining device and the horizontal angle of the table maintain orthogonal.

In addition the control system 100 further includes a storage unit 150 electrically coupled to the processing unit 140 and configured to store the compensation data 151. The compensation data 151 recording the change of the verticality of the machining device 220 when the control area 231 is at different temperatures. Through the compensation data 151, the processing unit 140 calculates the error angle required when the verticality of the machining device 220 and the horizontal angle of the table 210 maintain orthogonal(for example, if the current angle is 90.1 degrees, the error angle is 0.1 degrees), then generates the compensation signal based on the error angle and compensation data 151.

Referring to FIG. 1, in one embodiment, the machining device 220 further includes at least a column 221 and a spindle 222. The column 221 is arranged on the table 210 and the spindle 222 is arranged in the position corresponding to the workpiece to be processed on the column 221. The column 221 and the spindle 222 are provided with at least one sensing area 230 and at least one control area 231 respectively; each sensing area 230 is provided with the temperature measuring component 120 and each control area is provided with the temperature control device 130. However, in other embodiments, the temperature measuring component 120 and the temperature control device 130 may not be located in the adjacent area or may not have a corresponding relationship.

In one embodiment, the processing unit 140 calculates the corresponding compensation signal based on the temperature information of each sensing area 230 and outputs the compensation signal to each of the temperature control devices 130. Each of the temperature control devices 130 is made to adjust the temperature of the column 221 and the spindle 222. For example, the processing unit 140 outputs different compensation signals to each temperature control device 130 on the column 221 and the spindle 222 respectively. The temperature of the column 221 is controlled to 40 degrees Celsius and the temperature of the spindle 222 is adjusted to 45 degrees Celsius.

In one embodiment of the invention, the temperature control device 130 includes a heating element (e.g. an electric heating sheet) or a cooling element (e.g. a refrigerating piece). The temperature control device 130 may also include both the heating element and the cooling element. The temperature control device 130 adjusts an electrical signal applied to the heating element or the cooling element respectively according to the compensation signal to adjust the temperature of the control area 231 by means of exothermic or endothermic.

In the foregoing embodiment the processing unit 140 calculates an error angle of verticality based on the compensation data for the temperature information of each sensing area 230 respectively. The adjusted temperature values needed to correct each corresponding temperature control area 231 are then calculated independently. In other embodiments, the temperature information of all sensing regions 230 can also be referred to at the same time, and then the adjusted temperature values required for correction can be calculated, thereby generating a compensation signal.

The compensation data 151 can be a combination of polynomial regression equations. Please refer to the following figure for an example of four sets of sensing areas 230 and 231 corresponding to the unit 200 respectively. Among them, “temperature control A” represents the temperature expectation of one of the control areas 231, and “temperature sense 1” is the current temperature information of one of the sensing regions 230. The “error angle” is calculated by the processing unit 140 (in other embodiments, when the machining device 220 is vertical, the “horizontal angle” may also be used as the “error angle”. Is the variable in the equation.)The parameters in the following table can be adjusted according to the actual machine tool characteristics:

temperature control A=0.1372*(temperature sense 1)+0.5536*(temperature sense 2)+0.1885*(temperature sense 3)+0.0651*(temperature sense 4)+0.521*(error angle)+3.6147 Equation (1)

temperature control B=0.4346*(temperature sense 1)+0.1261*(temperature sense 2)+0.4287*(temperature sense 3)+0.436*(error angle)−0.0449*(temperature sense 4)+3.0608 Equation (2)

temperature control C=0.7228*(temperature sense)+0.4180*(temperature sense2)−0.9005*(temperature sense 3)+0.1875*(temperature sense 4)+0.602* (error angle)+25.891 Equation (3)

temperature control D=0.8798*(temperature sense 1)−0.3803*(temperature sense 2)−0.0445*(temperature sense 3)+0.1575*(temperature sense 4)+0.147*(error angle)+10.4401 Equation (4)

In one embodiment, in order to establish the compensation data 151, it is necessary to obtain a machining device 220 compensation data and a table 210 compensation data respectively. The method of obtaining the machining device compensation data is as follows: firstly, driving the machining tool 200 to start the operation of the machining tool 200. Then, through the temperature measuring component 120, analyzing a temperature distribution and thermal deformation of each part of the machining device 220. Dividing at least one sensing area 230 and at least one control area 231 according to the temperature distribution of each part of the machining device 220. Finally, through the temperature control device 130, adjusting the temperature of the control area 231 to obtain the machining device 220 compensation data. For example, the temperature of each part on the machining device 220 is adjusted one by one to judge the shape variable of other parts on the machining device 220; When heated or endothermic, the obvious temperature change is set as sensing area 230, and the position that can change other regional shape variable is set as temperature control area 231.

After adjusting the temperature of the control area 231 through the temperature control device 130 several times, the interaction between the verticality of the spindle 222 and the control area 231 at different temperatures can be recorded. And then get the machining device 220 compensation data. For example, when the control area of 231 is 67 degrees Celsius, the verticality of the machining spindle 222 is shifted by 3 degrees.

The method of obtaining the table 210 compensation data is as follows: firstly, adjusting a position of the table 210 and recording the horizontal angle of the table 210 at different positions through the horizontal monitoring unit 110. In one embodiment, the position of the table 210 depends on one of the conveying systems under the table 210. The manufacturer can change the position of the table 210 by adjusting the X axis and Y axis of the conveying system.

When the table 210 is located in different positions, due to the impact of the placement of the workpiece or the overall center of gravity of the machine tool 200, the horizontal angle of the table 210 may be changed. At this time, analyzing an error angle between the verticality of the machining device 220 and the horizontal angle of the table 210 when the table 210 is in different positions; then, according to the error angle, calculating a compensation temperature for correcting the error angle. After repeated recording of data at different locations, the table compensation data can be obtained (for example, when the error angle is 10 degrees, the compensation temperature should be 55 degrees Celsius).

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A control system applied to a machine tool comprising a table and a machining device, and the control system comprising:
at least one horizontal monitoring unit arranged on the table and configured to measure a horizontal angle of the table;
at least one temperature measuring component arranged on a sensing area of the machining device and configured to detect a temperature information of the sensing area;
at least one temperature control device arranged on a control area of the machining device and configured to adjust the temperature of the control area; and
a processing unit electrically coupled to the horizontal monitoring unit, the temperature measuring component and the temperature control device, wherein the processing unit is configured to receive the horizontal angle from the horizontal monitoring unit and the temperature information from the temperature measuring component and to output a compensation signal to the temperature control device according to the horizontal angle and the temperature information, so that the temperature control device adjusts the temperature of the control area on the machining device.

2. The control system of claim 1, further comprising:
a vertical monitoring unit arranged on the machining device and configured to measure a verticality of the machining device, wherein the compensation signal is used to adjust the temperature of the control area so that the verticality of the machining device and the horizontal angle of the table maintain orthogonal.

3. The control system of claim 2, further comprising:
a storage unit electrically coupled to the processing unit and configured to store a compensation data recording a change of the verticality of the machining device when the control area is at different temperatures.

4. The control system of claim 3, wherein the processing unit calculates an error angle required when the verticality of the machining device and the horizontal angle of the table maintain orthogonal, and then generates the compensation signal based on the error angle and compensation data.

5. The control system of claim 1, wherein the machining device comprises a column and a spindle, in which the column and the spindle are provided with at least one sensing area and at least one control area respectively, each sensing area is provided with the temperature measuring component, and each control area is provided with the temperature control device.

6. The control system of claim 1, wherein the temperature control device comprises a heating element and a cooling element , in which the temperature control device adjusts an electrical signal applied to the heating element or the cooling element respectively according to the compensation signal.

7. A control method applied to a machine tool and a control system, wherein the machine tool includes a table and a machining device; the control method comprising:
establishing a compensation data in the control system;
obtaining a horizontal angle of the table and a temperature information of a sensing area on the machining device through a horizontal monitoring units and a temperature measuring component of the control system respectively;
outputting a compensation signal according to the compensation data; and
according to the compensation signal, driving a temperature control device in the control system to adjust the temperature of a control area on the machining device.

8. The control method of claim 7, further comprising:
measuring a verticality of the machining device through a vertical monitoring unit in the control system; the compensation data recording a change of the verticality of the machining device when the control area is at different temperature, so that after the temperature of the control area is adjusted, the verticality of the machining device and the horizontal angle of the table maintain orthogonal.

9. The control method of claim 8, further comprising:
calculating an error angle required when the verticality of the machining device and the horizontal angle of the table maintain orthogonal, then generating the compensation signal based on the error angle and compensation data.

10. The control method of claim 7, wherein the temperature control device comprises a heating element and a cooling element , in which the temperature control device adjusts an electrical signal applied to the heating element or the cooling element respectively according to the compensation signal.

11. The control method of claim 7, further comprising:
obtaining a machining device compensation data and a table compensation data respectively to establish the compensation data.

12. The control method of claim 11, further comprising:
driving the machine tool to start the operation of the machine tool;
analyzing a temperature distribution and thermal deformation of each part of the machining device through the temperature measuring component;
dividing at least one sensing area and at least one control area according to the temperature distribution of each part of the machining device; and
adjusting the temperature of the control area to obtain the machining device compensation data through the temperature control device.

13. The control method of claim 12, further comprising:
adjusting a position of the table and recording the horizontal angle of the table at different positions through the horizontal monitoring unit;
analyzing an error angle between the verticality of the machining device and the horizontal angle of the table when the table is in different positions; and
according to the error angle, calculating a compensation temperature for correcting the error angle and obtaining the table compensation data.
